(19) United States
(12) Patent Application Publication
(10) Pub. No.: US 2016/0229229 A1
(43) Pub. Date: Aug. 11, 2016

(54) TIRE HAVING AN EVOLVING ASYMMETRIC TREAD PATTERN

(71) Applicants: COMPAGNIE GENERALE DES ETABLISSEMENTS MICHELIN, Clermont-Ferrand (FR); MICHELIN RECHERCHE ET TECHNIQUE, S.A., Granges-Paccot (CH)

(72) Inventors: Patrick PALLOT, Clermont-Ferrand (FR); Mathleu DELBOS, Clermont-Ferrand (FR); Patrick DAYET, Clermont-Ferrand (FR); Jacky PINEAU, Clermont-Ferrand (FR); Olivier MUHLHOFF, Clermont-Ferrand (FR)

(73) Assignees: COMPAGNIE GENERALE DES ETABLISSEMENTS MICHELIN, Clermont-Ferrand (FR); MICHELIN ROCHERCHE ET TECHNIQUE, S.A., Granges-Paccot (CH)

(21) Appl. No.: 15/021,648

(22) PCT Filed: Aug. 5, 2014
(86) PCT No.: PCT/EP2014/066764

§ 371 Date: Mar. 11, 2016

(30) Foreign Application Priority Data
Sep. 11, 2013 (FR) 1358717

(51) Int. Cl. B60C 11/03

(52) U.S. Cl. CPC B60C 11/033; B60C 11/0302; B60C 11/0304; B60C 11/0323; B60C 2011/0353

(57) ABSTRACT

Passenger vehicle tire having a tread extended on either side by sidewalls, this tread being provided with an asymmetric tread pattern with respect to a median plane that divides this tread into two parts with the same axial width, this axial width being measured in a direction parallel to the axis of rotation, an external part and an internal part, this external part being situated between this median plane and the sidewall intended to be positioned on the outside of a vehicle, and the internal part being situated between the same plane and the sidewall intended to be positioned towards the inside of the same vehicle, the internal part and the external part each having at least one void that forms a groove or is intended to form a groove when the tread has partially worn away, these voids defining, in the new state and for each (internal and external) part, a total voids volume Vi0 and Ve0, respectively, and a voids surface ratio Ti0 and Te0, respectively, these ratios being other than zero and such that, in the new state, there is a ratio R0 between the voids volume of the internal part and the voids volume of the external part, and for each degree of wear (U) chosen between the initial state and the wear limit of the tread there is a ratio RU between the voids volume of the internal part and the voids volume of the external part, this tire being characterized in that the ratio RU is greater than the ratio R0 at least starting from a degree of wear of 80% measured over the thickness of the tread to be worn away.

This application is a 371 national phase entry of PCT/EP2014/066764 filed 5 Aug. 2014, which claims the benefit of French Patent Application No. 1358717, filed 11 Sep. 2013, the contents of which are incorporated herein by reference for all purposes.

### BACKGROUND

The present invention relates to the tread pattern of car tire treads and more precisely to asymmetric tread patterns.

### DESCRIPTION OF RELATED ART

It is known practice to provide a tread of a tire intended to be fitted on a car with a plurality of circumferentially and transversely oriented grooves, these grooves delimiting a plurality of raised elements that form a tread pattern. The external surface of these elements constitutes a tread surface intended to come into contact with a roadway during running. The grooves and sipes form a visible tread pattern on the tread surface in the new state. With wear, this pattern can be preserved or modified.

It is also known practice to produce asymmetric tread patterns, that is to say tread patterns that are different on either side of the median plane of the tread, this plane dividing said tread into two halves with the same axial width. The advantage of asymmetric tread patterns is that it makes it possible to differentiate the parts of the tire depending on their position with respect to the side that is intended to be on the outside of a vehicle when the tire is mounted on this vehicle.

A tire mounted on a vehicle has a contact patch centred on the line of its equatorial median plane when the vehicle is running in a straight line. When negotiating bends, a transfer of load to the tires situated towards the outside of the path followed by the vehicle occurs, while the tires situated on the inside are relieved of load. More precisely, this transfer of load takes place to the part of these tires that is axially on the outside. This transfer of load results in a modification in the form of the contact patches of the tires.

Patent document WO-2007071284-A1 describes a tire in which the tread is provided with an asymmetric tread pattern, this tread pattern comprising two grooves on the inner side but a single groove on the outer side. This tread pattern is preserved throughout the service life of the tire.

However, it has been noted that with wear, a reduction in the grip performance on wet ground occurred with this type of tire.

### DEFINITIONS

The reference conditions of the tire on its mounting rim as defined by the E.T.R.T.O. European standard specify the inflation pressure corresponding to the maximum admissible load-bearing capability of the tire as indicated by its load index and its speed rating. However, the conditions of use of a tire on a vehicle differ from the reference conditions in that the load carried is equal to around 80% of the maximum admissible load.

The contact patch in which the tire is in contact with the roadway is obtained with the tire at a standstill mounted on the mounting rim and under conditions of use. The total surface area for contact under these conditions is denoted S, this surface area being equal to the total surface area delimited by the external contour of the contact patch of the tire under these reference conditions; this surface area includes the recessed parts.

The voids surface ratio of a tread pattern is equal to the ratio between the surface area of the voids (essentially formed by grooves) delimited by the raised elements (blocks, ribs) and the total surface area (surface area for contact of the raised elements and surface area of the voids). A low voids surface ratio indicates a large surface area for contact of the tread and a small surface area of voids between the raised elements.

Similarly, a voids surface ratio for a circumferentially extending part is defined as being the ratio between the surface area of voids in this part and the total surface area of this tread part, this total surface area including the surface area of material and the surface area of the voids that open onto the surface of said part.

The voids volume ratio is equal to the ratio between the volume of all of the voids and the volume of the tread, the latter including both the volume of material and the volume of voids.

Similarly, a voids volume ratio for a part of a tread is defined as being the ratio between the volume of voids in this part and the total volume of this tread part, this total volume including the volume of material and the volume of voids of said part.

This voids surface ratio and this voids volume ratio are defined in the new state of a tread and at any intermediate degree of wear of said tread.

A block is a raised element formed on a tread, this element being delimited by voids or grooves and comprising more than two lateral walls and a contact face, the latter being intended to come into contact with the roadway during running.

A rib is a raised element formed on a tread, this element being delimited by two grooves. A rib comprises two lateral walls and a contact face, the latter being intended to come into contact with the roadway.

A radial direction means a direction which is perpendicular to the axis of rotation of the tire (this direction corresponds to the direction of the thickness of the tread).

An axial or transverse direction means a direction parallel to the axis of rotation of the tire.

A circumferential direction means a direction which is tangential to any circle centered on the axis of rotation. This direction is perpendicular both to the axial direction and to a radial direction.

A cut denotes either a groove or a sipe and corresponds to the space delimited by the walls of material that face one another and are spaced apart from one another by a mean distance, it being possible for this mean distance to be zero. What differentiates a sipe from a groove is precisely this distance; in the case of a sipe, this is a distance suitable for the opposing walls to come into at least partial contact as contact is made with the roadway, As a general rule, for a sipe intended for a passenger vehicle tire, this distance is at most equal to 2 millimeters (2 mm) on the tire in the new state. In the case of a groove, the walls of this groove cannot come into contact with one another during running under conditions of use.

### SUMMARY

The exemplary embodiments aim to preserve the grip performance on a wet roadway with wear of a tread comprising an asymmetric tread pattern.

To this end, the subject of the exemplary embodiments is a passenger vehicle tire comprising a tread extended on either side by sidewalls, this tread having a tread surface intended to come into contact with a road. This tread is provided with an asymmetric tread pattern with respect to a median plane that divides this tread into two parts with the same axial width (measured in a direction parallel to the axis of rotation), an external part and an internal part, this external part being situated between this median plane and the sidewall intended to be positioned on the outside of a vehicle, and the internal part being situated between the same plane and the sidewall intended to be positioned towards the inside of the same vehicle. Each part comprises at least one void, that is to say a cavity that forms, in the new state, a groove that opens onto the tread surface or a cavity underlying the tread surface in the new state and is intended to form a groove when the tread has partially worn away. These voids define, in the new state and for each (internal and external) part, a total voids volume Vi0 and Ve0, respectively, and a voids surface ratio Ti0 and Te0, respectively, these ratios being other than zero, and such that, in the new state, there is a ratio R0 between the voids volume of the internal part and the voids volume of the external part, and for each degree of wear (U) measured between the initial state and the wear limit of the tread there is a ratio RU between the voids volume of the internal part and the voids volume of the external part. This tire is characterized in that the tread comprises a plurality of hidden voids formed on the tread surface in the new state. These hidden hollows are intended to form new grooves after a predetermined amount of wear, most of these voids being positioned on the inner side of said tread. The latter voids can be oriented in a transversal or circumferential direction.

Moreover, the tire is characterized in that, when the tread has partially worn away, the ratio RU becomes greater than the ratio R0 and remains so until the tread is completely worn.

More preferentially, the ratio RU is greater than the ratio R0 starting from partial wear corresponding to 60% of the total thickness of the tread to be worn away.

The total thickness of the tread to be worn away means in this case the maximum thickness measured between the tread surface in the new state of the tread and the tread wear limit indicators imposed by legislation. These tread wear limit indicators have a height measured with respect to the bottom of the grooves of 1.6 mm in Europe. The total thickness to be worn away is obtained from the difference between the depth of the grooves and the height of the tread wear limit indicators.

Advantageously, the ratio R0 is greater than 1.

Advantageously, the tire according to an exemplary embodiment is such that the voids surface ratio Te0 of the external part in the new state is greater than the voids surface ratio Ti0 of the internal part.

Preferentially, the tire is such that the ratio RU is at least equal to 1.1 times the ratio R0 and even more preferentially at least equal to 1.2 times the ratio R0.

According to one exemplary embodiment, the ratio RU increases for different successive levels of wear.

According to another exemplary embodiment, the ratio RU increases continuously as a function of the wear starting from a particular depth.

In order to produce a tire according to the exemplary embodiment(s), it is possible to provide for the voids volume of the external part to be virtually zero, or zero, starting from a degree of wear greater than or equal to 75% of the total thickness to be worn away.

Advantageously, the tire according to the exemplary embodiments is such that the voids surface ratio increases with the degree of tread wear on the internal part, whereas it decreases on the external part.

In a variant embodiment of the tire, the tread comprises a plurality of grooves with a circumferential overall orientation, at least some of the circumferential grooves formed on the internal part of the tread having a profile as seen in cross section such that the width of these grooves over the tread surface increases with the degree of tread wear.

“Transverse” should be interpreted broadly here in order to also encompass any oblique direction, that is to say forming an angle of at most 60 degrees with the direction of the axis of rotation of the tire.

Preferentially, the voids surface ratio Te0 of the external part PE in the new state is greater than the voids surface ratio Ti0 of the internal part PI in the new state.

Further features and advantages of the exemplary embodiments will become apparent from the description given hereinafter with reference to the attached drawings, which show variant embodiments by way of nonlimiting examples.

### BRIEF DESCRIPTION OF THE DRAWINGS

FIG. 1 shows a plan view of a part of a tread according to an exemplary embodiment;

FIG. 2 shows a block of the tread according to FIG. 1 in cross section;

FIG. 3 shows a plan view of a part of the tread shown in FIG. 1 after partial wear;

FIG. 4 shows a cross-sectional view of a part of a tread according to a second exemplary embodiment;

FIG. 5 shows a cross-sectional view of a part of a tread according to a third exemplary embodiment;

FIG. 6 shows the tread from FIG. 5 after partial wear greater than 50%.

### DETAILED DESCRIPTION OF THE SPECIFIC EMBODIMENTS

In the figures accompanying this description, the same reference signs have been used to describe exemplary embodiments, where these reference signs refer to elements of the same nature, whether this nature is structural or functional.

FIGS. 1 to 3 show a first exemplary embodiment.

In this first exemplary embodiment, a tread 1 of a passenger vehicle tire is shown, this tread comprising, radially on the outside, a tread surface 10 intended to come into contact with a roadway during running. This tread 1 is provided with a tread pattern made in the thickness of the tread, this tread pattern being formed by voids (grooves, sipes, channels).

On account of its tread pattern, this tread imposes a preferred mounting direction that is identified for example on one of its sidewalls by a marking that indicates—for example—which sidewall of the tire should be positioned towards the outside of the vehicle when the tire provided with this tread is mounted on one of the axles of a vehicle (in the figures of the present application, the side intended to be positioned on the outside is identified by the letters “EXT”, while the other side is identified by the letters “INT”).

In the new state shown in this FIG. 1, a part of the tread surface 10 of the tread 1 is shown. The axis XX′ shows the intersection of the equatorial median plane of the tire with the plane of the figure; this axis XX′ cuts the tread surface 10 into two parts with the same axial width (that is to say in the direction of the roiling axis of the tire indicated by the axis YY′). An external part PE and an internal part PI are distinguished. When the tire is mounted on a vehicle, the external part PE is positioned so as to be visible from the outside of the vehicle. It is this external part PE which will be particularly stressed when negotiating bends. The other, interior part PI is positioned towards the inside of the vehicle. Said interior part is less stressed in bends since, as is known, a part of the load supported is transferred towards the external part and the tangential forces exerted by the roadway are reduced on the internal part compared with the tangential forces exerted by the same roadway on the external part.

The tread according to the exemplary embodiment shown in FIG. 1 comprises four circumferential grooves 21, 22, 23, 24 with the same depth equal to 7.8 mm, the circumferential grooves dividing this tread into a median rib 31 centered on the median plane XX′, two intermediate ribs 32, 33, and, axially towards the outside, two shoulder ribs 34, 35.

Also formed on the shoulder rib 35 of the external part PE are transverse grooves 45 that have a width of 4 mm and extend to a mean depth equal to 6.7 mm; this depth decreases axially towards the outer side, given the transverse profile of the tread surface on the shoulder rib. The intermediate rib 32 of the external part PE is provided with oblique grooves 46 that form an angle of 10 degrees with the axial direction YY′. These latter oblique grooves 46 only open into the circumferential groove 24 formed between the shoulder rib 35 and the intermediate rib 32. These oblique grooves 46 have the same geometric characteristics as the transverse grooves 45 formed on the shoulder rib 35. The walls delimiting these transverse and oblique ribs are planar and not inclined with respect to a direction perpendicular to the tread surface 10. Thus, the widths of these transverse grooves 45 and oblique grooves 46 are preserved in the depth.

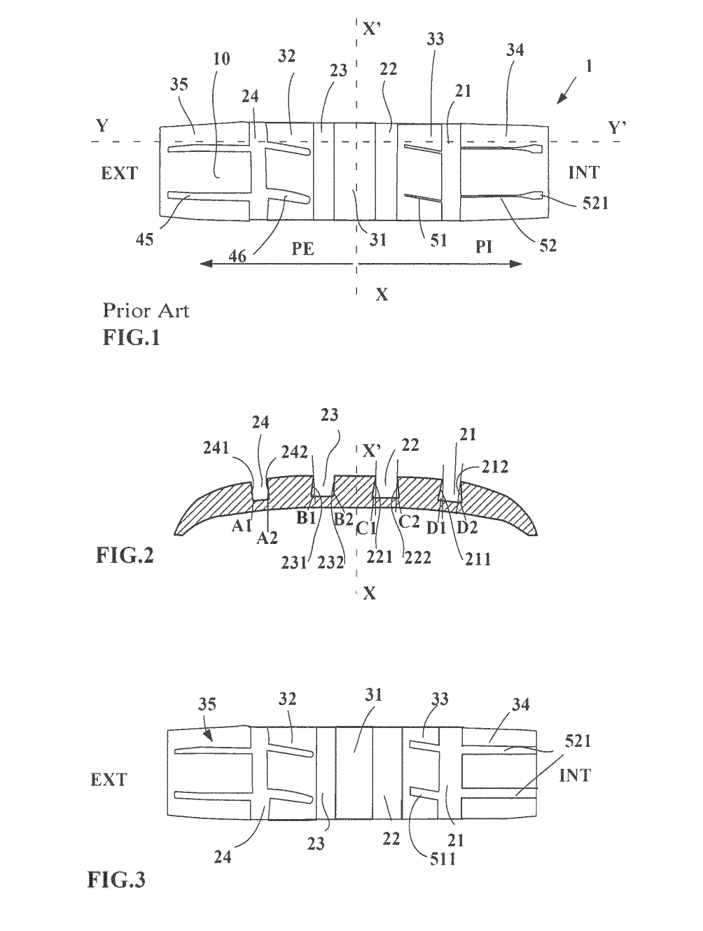

In FIG. 2, which shows the same tread in cross section in a meridian cross-sectional plane containing the axis of rotation YY′ of the tire, the profiles of the walls delimiting the circumferential grooves are distinguished. More specifically, the axially outermost circumferential groove 24 of the external part PE of the tread is delimited by walls 241, 242, the intersections of which with this cross-sectional plane are rectilinear and each form zero angles A1 and A2 with a direction perpendicular to the axis of rotation.

The other circumferential groove 23 of the external part of the tread comprises a first wall 231 that forms a negative angle B1 equal to 5 degrees with a direction perpendicular to the tread surface, and a wall 232 that forms, with one and the same direction, a zero angle B2. A negative angle of a wall should be understood as meaning that said wall is undercut, that is to say that it tends to widen the groove. The zero-angle wall 232 of this groove 23 is situated on the side of the median plane XX′ while the other wall 231 is situated axially towards the outside with respect to the wall 232. In this way, the width of the circumferential groove 23 situated between the median rib 31 and the intermediate rib 32 of the external part PE of the tread is equal to 11.5 mm in the new state and equal to 12.2 mm after corresponding total wearing away to the maximum depth of the grooves (i.e. a depth of 7.8 mm).

As far as the axially outermost circumferential groove 24 of the external part PE is concerned, the width equal, in the new state, to 9 mm, is preserved over the entire depth of this groove.

On the internal part PI, the circumferential grooves 21, 22 are distinguished from the circumferential grooves 23, 24 on the external part PE in that they have transverse profiles, seen in cross section in FIG. 2, which widen progressively in the depth of the tread. Thus, the circumferential groove 22 that is closest to the median plane XX′ has a width equal to 11.5 mm in the new state, while at full depth (7.8 mm) this width is equal to 13.7 mm. To this end, the walls 221, 222 that delimit this groove 22 form negative angles C1 and C2 equal to 10 degrees and 5 degrees, respectively, the wall forming the greatest angle in absolute terms being situated close to the median plane.

Furthermore, the circumferential groove axially on the outside of the internal part has a width equal to 10 mm in the new state and equal to 12.9 mm at a depth equal to 7.8 mm corresponding to the maximum depth of said circumferential groove. This circumferential groove 21 is delimited by a wall 211 that forms a negative angle D1 equal to 15 degrees with a direction perpendicular to the axis of rotation, and another wall 212 that forms a negative angle B2 equal to 10 degrees with the same direction, the smallest angle being formed by the wall 212 belonging to the shoulder rib 34 of the internal part P1.

Moreover, a plurality of sipes 51 are formed on the intermediate rib 33 and a plurality of sipes 52 are formed on the shoulder rib 34, these sipes being extended into the thickness of the strip by a widening 511, 521, respectively. These widenings are intended to form new transverse grooves 511, 521, visible in FIG. 3, when the tread has partially worn away. The widening 511 that extends the sipe 51 in the intermediate rib 33 has, as seen in cross section, a shape having a width equal to 4 mm. The widening 521 that extends the sipe 52 in the shoulder rib 34 has, as seen in cross section, a shape, having a width equal to 4 mm. As can be seen in FIG. 3, the sipes in the intermediate rib only open onto a circumferential groove, while the sipes in the shoulder rib open onto each side of said rib.

The tread pattern of the tread described by way of FIGS. 1 and 2 is asymmetric with respect to the median plane XX′ in that it has two different tread patterns on either side of this median plane. These patterns are formed by the edges formed by the voids (grooves and sipes). Asymmetry is preserved regardless of the level of partial wear.

A voids surface ratio Tso for the entire tread pattern of the tread is defined in the new state as being equal to the ratio between the surface area of the voids formed by the grooves and the total surface area (that is to say the possible surface area for contact of the raised elements and surface area of the voids). In the present case, the voids surface ratio in the new state is equal to 31.2%.

Similarly, a voids surface ratio Tseo for the external part PE is defined as being the ratio between the voids surface area of this part and the total surface area of this tread part, this total surface area including the material surface area and the surface area of the voids that open onto the surface of said part. In the present case, this voids surface ratio Tseo of the external part is equal to 35% in the new state. For the internal part, the voids surface ratio Tsio is equal to 27.4% in the new state.

The total voids volume Veo of the external part PE comprises the volume of the circumferential grooves and that of the transverse and oblique groups; in the present case, it is equal to 417750 mm³. For the internal part, the voids volume Vio is equal to 428153 mm³. This results in a voids volume ratio Tveo for the external part of 35.74% and a voids volume ratio Tvio for the internal part of 36.63% in the new state.

These voids surface ratios and voids volume ratios overall or in each internal or external part and the voids volumes are also defined for each intermediate state of tread wear.

In the case presented here, after wear equal to 64% of the depth of the circumferential grooves (corresponding to wear equal to 80% of the total tread thickness to be worn away), the following values are obtained:

Voids volume of the external part PE: Ve=158009 mm³

Voids volume of the internal part PI: Vi=184537 mm³

Voids surface ratio of the external part PE: Tse=35.5%

Voids surface ratio of the internal part PI: Tsi=40.7%

Voids volume ratio of the external part PE: Tve=35.53%

Voids volume ratio of the internal part PI: Tvi=41.50%

The ratio RO between the total voids volume of the internal part PI and the total voids volume of the external part PE in the new state is equal to 1.025 (Vio/Veo).

This ratio after partial wear corresponding to 64% of the thickness of the tread is denoted RU and, in the present case, is equal to 1.168 (Vi/Ve).

The ratio RU/RO for partial wear equal to 64% of the total depth of the grooves is in this case equal to 1.14.

Thus, after partial tread wear, the distribution of the voids between the internal part PI and the external part PE has evolved so as to substantially increase the proportion of the voids in the internal part relative to the proportion of the voids in the external part.

FIG. 3 shows a partial view of the surface of the tread after this partial wear. New transverse grooves 511 and 521 can be distinguished on the internal part of the tread. Furthermore, the widths of the circumferential grooves measured on the new tread surface of the tread are reduced for the grooves in the external part while they have been increased for the grooves in the internal part (these reductions and increases being measured with respect to the widths on the tread surface in the new state).

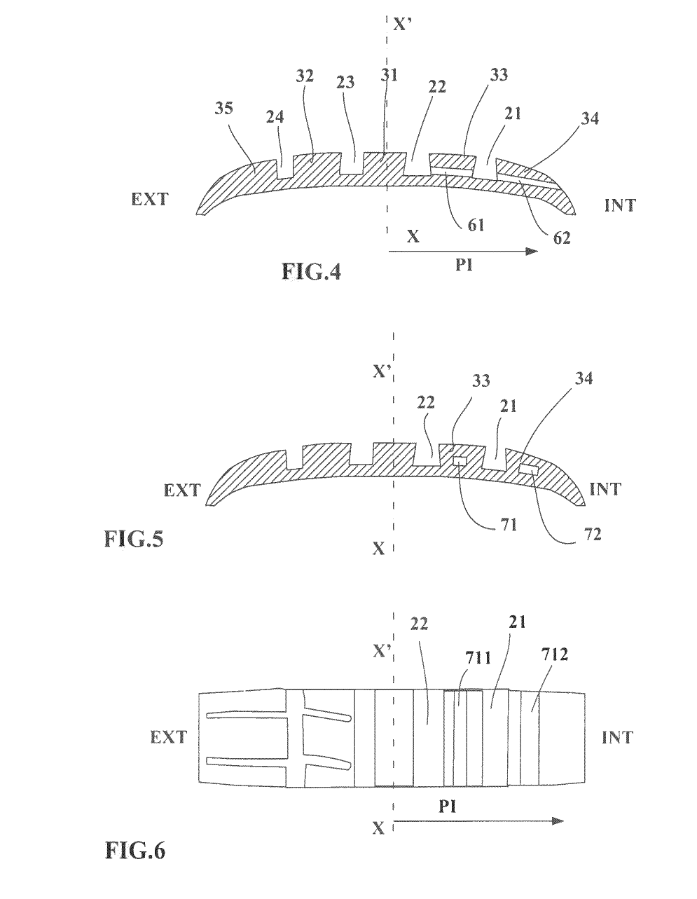

FIG. 4 shows a tread 1 according to another exemplary embodiment in meridian cross section (in a plane containing the axis of rotation of the tire).

According to this exemplary embodiment, the tread 1 comprises two circumferential grooves 23, 24 and a plurality of transverse or oblique grooves in its external part PE in a configuration similar to that described by way of FIGS. 1 to 3 for the first variant. On its internal part PI, in an identical manner to the first variant, the tread comprises two circumferential grooves 21, 22 having the same profiles, viewed in cross section, as for the first exemplary embodiment.

Moreover, in this internal part PI, a plurality of channels 61, 62 are formed under the tread surface in the intermediate rib 33 and the shoulder rib 34 in the new state. These channels 61, 62 open onto the outside of the tread and into each of the circumferential grooves in the internal part. These channels are suitable for forming new transverse grooves after wear of around 60% of the total thickness of the tread to be worn away. These channels 61, 62 can be filled with a material that facilitates manufacture and can be removed naturally once the tread wear reaches said channels. It is also possible to use molds comprising lingers that mould these transverse or oblique channels under the tread surface in the new state.

After more than half of the thickness of the new tread has been worn away, the appearance of new grooves also makes it possible to increase the voids surface ratio on the internal part PI, and also the number of edges and the total length of said edges. This increase in the total length of edges on the inner part PI combined with an increase in the ratio RU relative to the ratio R0 evaluated in the new state improves the performance on wet ground following wear even more, while improving road holding in bends on a dry roadway.

In a third exemplary embodiment shown in cross section in FIG. 5 and in plan view in FIG. 6, instead of the transverse channels underlying the tread surface in the new state of the second variant, one respective channel 71, 72 is formed in each of the two axially external ribs 33, 34 of the internal part PI of the tread 1. These channels 71, 72 are oriented circumferentially and formed radially under the tread surface in the new state. Each of these channels 71, 72 is intended to form, after partial tread wear, a new circumferential groove 711, 712, as can be seen in the plan view in FIG. 6.

This solution makes it possible to achieve greater efficiency for a sports-type tire by increasing the relative voids volume proportion in the internal part PI compared to the voids volume proportion in the external part PE of a tire with wear. Moreover, the formation of additional edges during the creation of new circumferential grooves after partial wear makes it possible to improve the transverse stress performance (on wet ground).

Although the exemplary embodiments have been described in a general manner with the aid of three examples, it should be understood that this disclosure is not limited to these exemplary embodiments and that in particular any combination of said variants is part of the disclosure. Grooves such as those described in the patent publication WO 2011/039194 can be employed, be it on the internal part or on the external part or even on both parts.

1. Passenger vehicle tire comprising
a tread extending on either side by sidewalls, this tread having a tread surface for contacting a road,
this tread having an asymmetric tread pattern with respect to a median plane XX′ that divides this tread into two parts with the same axial width, this axial width measuring in a direction parallel to the axis of rotation,
an external part PE and an internal part PI, this external part PE is situated between this median plane XX′ and the sidewall for positioning on the outside of a vehicle, and
the internal part PI is situated between the same plane and the sidewall for positioning towards the inside of the same vehicle, the internal part and the external part each having at least one void for forming a groove when the tread has partially worn away,
these voids defining, in the new state and for each of the internal and external parts,
a total voids volume Vi0 and Ve0, respectively, and
a voids surface ratio Ti0 and Te0, respectively, these ratios are other than zero and wherein, in the new state, there is a ratio R0 between the voids volume of the internal part and the voids volume of the external part, and
for each degree of wear (U) chosen between the initial state and the wear limit of the tread there is a ratio RU between the voids volume of the internal part and the voids volume of the external part,
this tire, wherein the tread includes
a plurality of hidden voids for forming new grooves after a predetermined amount of wear, most of these hidden voids are positioned in the internal part PI of said tread, and
wherein, when the tread has partially worn away, the ratio RU is greater than the ratio R0 and remains so until the tread is completely worn.

2. The tire according to claim 1, wherein the partial wear from which the ratio RU becomes greater than the ratio R0 is equal to at least 60% of the thickness of the tread to be worn away.

3. The tire according to claim 1, wherein the ratio R0 is greater than 1.

4. The tire according to claim 1, wherein the ratio RU is equal to at least 1.1 times the ratio R0.

5. The tire according to claim 4, wherein the ratio RU is equal to at least 1.2 times the ratio R0.

6. The tire according to claim 1, wherein the ratio RU increases for different levels of wear.

7. The tire according to claim 6, wherein the ratio RU increases continuously as a function of the tread wear.

8. The tire according to claim 1, wherein the voids volume of the external part is virtually zero, or zero, starting from a degree of wear greater than or equal to 75% of the total thickness to be worn away.

9. The tire according to claim 1, wherein the voids surface ratio increases with the degree of tread wear on the internal part PI of the tread, wherein it decreases on the external part PE of the tread.

10. The tire according to claim 1, wherein the tread comprises
a plurality of grooves with a circumferential overall orientation, at least some of the circumferential grooves formed on the internal part of the tread having a profile in cross section such that the width of these grooves over the tread surface increases with the degree of tread wear.

11. The tire according to claim 1, wherein the hidden voids are oriented in a transverse direction.

12. The tire according to claim 1, wherein, in the new state, the voids surface ratio Te0 of the external part PE is greater than the voids surface ratio Ti0 of the internal part PI.
